(19) United States
(12) Patent Application Publication
(10) Pub. No.: US 2010/0061460 A1
(43) Pub. Date: Mar. 11, 2010

(54) METHOD AND APPARATUS FOR RECOVERING A DISPLAY PICTURE SEQUENCE FROM A CODED DIGITAL VIDEO SIGNAL

(76) Inventors: Michael Weber, Hannover (DE); Ingo Huetter, Pattensen (DE)

Correspondence Address: Robert D. Shedd, Patent Operations;THOMSON Licensing LLC, P.O. Box 5312, Princeton, NJ, 08543-5312, US

(21) Appl. No.: 12/312,414

(22) PCT Filed: Nov. 22, 2007
(86) PCT No.: PCT/EP2007/062698

§ 371 Date: May 8, 2009

(30) Foreign Application Priority Data
Nov. 23, 2006 (DE) 102006055702.6

(51) Int. Cl. H04N 7/26

(52) U.S. Cl. 375/240.16; 375/E07.123

(57) ABSTRACT

A method for recovering a display picture sequence from a coded digital video signal with a variable data rate comprises the steps of
decoding the coded digital video signal in order to obtain an intermediate picture sequence,
detecting the data rate of the coded digital video signal, and a quantity representative of the amount of motion in the pictures of the intermediate picture sequence, and
filtering the intermediate picture sequence in order to obtain the display picture sequence,
   wherein a filtering characteristic of the filtering step is defined on the basis of the detected data rate and the detected motion quantity.

The present invention relates to the digital transmission of video signals, typically via radio, but also via line-connected channels such as the Internet, for instance.

Digital video transmission technology is becoming more and more widespread, whether in areas in which analogue transmission technology was formerly used or in those areas which only become possible by virtue of the digital technology. A digital video picture is obtained initially, whether in a video camera or in a computer animation, in a format in which three brightness values for the primary colours, red, green, blue are present for each pixel of the picture. The direct transmission of such video data requires an extremely high bandwidth of the transmission channel. In order to reduce the bandwidth requirement and thus also the costs of the transmission, a coding that reduces the quantity of data to be transmitted is generally performed.

A coding can comprise a data compression carried out for each respective individual picture. The compression ratio that can be achieved in this case depends on the amount of detail in the pictures to be transmitted. Since said amount of detail is generally variable, the data rate on the transmission channel can vary temporally—assuming by a fixed picture rate. There are furthermore coding methods which involve transmitting not just complete pictures but rather—at least in part—only difference information describing the changes between successive pictures. The difference information can be determined between two respective identical pixels of successive pictures, or a picture can be broken down into a multiplicity of small blocks, and the transmitted difference information contains respective indications about changes in the colour values of the individual pixels of a block and also the extent of the motion of the block from one picture to the next. In this case, too, the data rate to be transmitted—the picture rate assumed to be constant—is not constant, rather the greater the motion of the picture content, the higher the amount of data to be transmitted is.

Furthermore, so-called scaling coding is known, which are distinguished by the fact that data losses in the transmission channel only lead to a loss of resolution in the transmitted pictures. This scalability can also be utilized by a transmitter varying the transmission rate of coded data depending on the capacity available on the respective utilized transmission channel. The data rate of the signal arriving at a receiver is in this case likewise variable, but this variability does not depend on the picture content of the video signal to be transmitted, but rather is controlled in such a way that the highest possible transmission quality is realized at every point in time.

Transmission channels having a variable capacity occur in a multiplicity of applications, for example when transmitting video data in packet-oriented networks such as the Internet, for instance, where a multiplicity of concurrent transmission processes compete for available transmission bandwidth, or in the case of radio transmission on channels on which the transmission quality depends on climatic influences, such as in cellular mobile radio networks, for instance. However, even if a transmission infrastructure having an inherently fixed bandwidth is used, such as cable or weather-insensitive radio links, for instance, similar problems can occur. This is because if, on such a channel having a fixed bandwidth, the intention is to transmit a coded video signals having a variable bandwidth as described above, said bandwidth must essentially correspond to the maximum bandwidth of the signal. In times when the bandwidth of the signal is smaller, part of the channel capacity remains unutilized, which is uneconomic. If a large number of signals are transmitted on an identical channel with a correspondingly large bandwidth, this bandwidth can be utilized better in percentage terms since in general not all the signals concurrently have a high bandwidth requirement, although the bandwidth available for a given channel varies to the extent to which the bandwidth requirement of the other channels fluctuates.

In parallel with the advancing spread of digital video transmission technology, pixel-oriented display devices are increasingly being used, that is to say that conventional CRT picture tubes are progressively being replaced by, for example, LCD or plasma displays having a high resolution. In this case, it is found that pictures recovered from a coded digital video signal with a low data rate often appear worse on such a high-quality pixel-oriented display than on a conventional CRT picture tube.

It is an object of the invention to specify a method and an apparatus for recovering a display picture sequence from a coded digital video signal with a variable data rate which still permits an appealing reproduction quality even when the video signal has a low data rate.

The object is achieved firstly by virtue of the fact that, in a method for recovering a display picture sequence from a coded digital video signal with a variable data rate, in which the coded digital video signal is decoded in order to obtain an intermediate picture sequence, and the intermediate picture sequence is filtered in order to obtain the display picture sequence, the data rate of the coded digital video signal is detected and a filtering characteristic of the filtering step is controlled on the basis of the detected data rate. This control makes it possible, at a time at which a high data rate indicates good transmission conditions, to leave the intermediate picture sequence essentially unchanged, while at a low data rate, on the basis of which poor transmission conditions can be expected, a higher degree of filtering is necessary in order to suppress artefacts resulting from the low data rate in the display picture sequence.

The data rate can be determined as the volume of data per picture of the coded digital video signal or else as the volume of data per unit time of the coded digital video signal.

The object is furthermore achieved by means of a method, in particular, but not necessarily as defined above, in which, furthermore, a quantity representative of the extent of motion in the pictures of the intermediate picture sequence is detected, and a filtering characteristic of the filtering step is controlled on the basis of the detected quantity.

The detection of said quantity is preferably effected on the coded digital video signal, such that the detected value of the quantity can be used for defining the filtering characteristic with minimal delay, possibly still for data of the same picture on which it was determined.

For this purpose, the coded digital video signal is expediently a sequence of data records that each code a picture, wherein each picture is subdivided into blocks and the data record comprises motion vectors specifying the extent of motion of an assigned block between the coded picture and a preceding or succeeding picture.

The quantity representative of the motion can be detected in a simple manner by integration of the motion vectors over at least part of the area of the coded picture.

According to one preferred application, the coded digital video signal is one of a plurality of video signals transmitted on a common channel, such as, for instance, a video signal according to the DVB-T or DVB-S standard.

The filtering step preferably comprises a low-pass filtering. Control of the filtering may be based on the fact that high-frequency picture components are suppressed to an extent that is ever increasing, the lower the detected data rate. In order to avoid abrupt changes in the filtering characteristic, the filtering characteristic applied to a picture of the intermediate picture sequence is in this case expediently defined on the basis of the data rate of the coded digital video signal that corresponds to said picture and to at least one preceding picture.

The control can also comprise suppressing high-frequency picture components to an extent that is increasing with an increasing detected extent of motion.

The low-pass filtering is preferably performed over the entire area of each picture in order to avoid discontinuities in the picture that can occur at the block boundaries e.g. in the case of filtering performed block by block.

In one embodiment a matrix is generated for each respective transmission method and/or display device. The matrix contains evaluation values indicating the image quality for selected pairs of values for data rate and amount of motion. For each data pair the evaluation value determines whether the image quality is to be improved by corresponding measures, e.g. low pass filtering. The matrix is preferably stored in the decoder. A decision, which measure is to be applied for improving the perceived image quality, is made based upon the determined data rate and the amount of motion. An exemplary matrix contains values for small, medium and high data rate as well as for little, slow and fast motion. The exemplary matrix already allows for 9 possible combination pairs.

The object is furthermore achieved by means of an apparatus for recovering a display picture sequence from a coded digital video signal with a variable data rate, comprising a decoder for decoding the coded digital video signal in order to obtain an intermediate picture sequence, a filter for filtering the intermediate picture sequence in order to obtain the display picture sequence, and a measuring device for detecting the data rate of the coded digital video signal, wherein a filtering characteristic of the filter can be controlled on the basis of the detected data rate. Furthermore, the object is achieved by means of an apparatus for recovering a display picture sequence comprising a decoder and a filter as described above, and a measuring device for detecting a quantity representative of the extent of motion in the pictures of the intermediate picture sequence, wherein a filtering characteristic of the filter can be controlled on the basis of the detected quantity.

Further features and advantages of the invention will be apparent from the following description of exemplary embodiments with reference to the accompanying figures, in which:

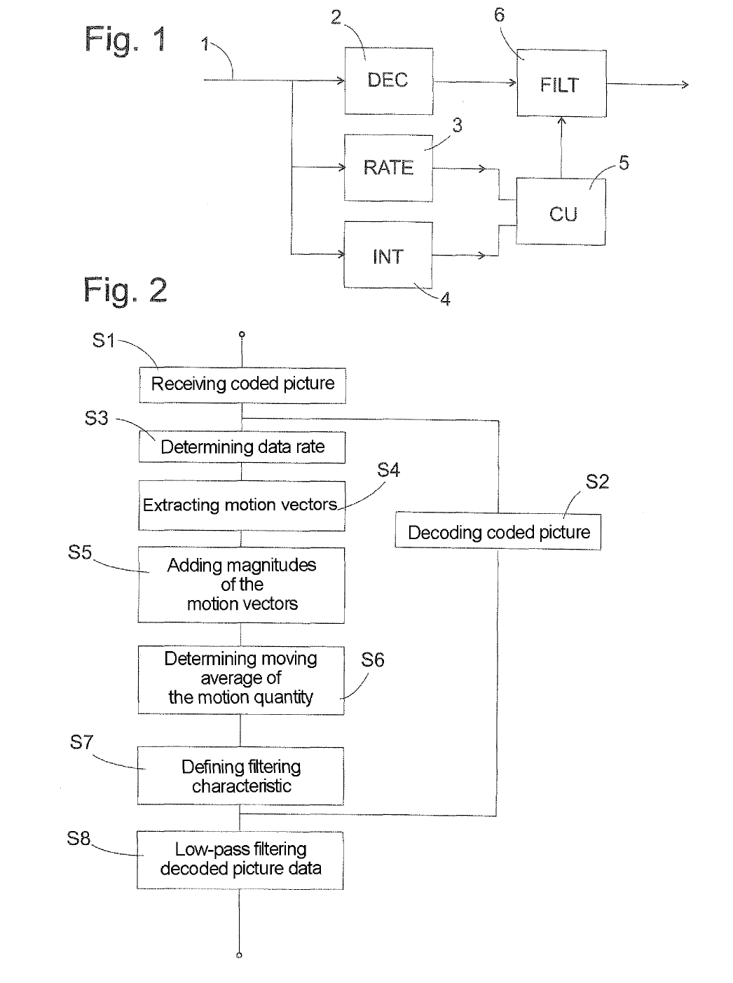

FIG. 1 shows a block diagram of an apparatus according to the invention; and

FIG. 2 shows a flowchart of a method according to the invention.

The apparatus for recovering a display picture sequence as illustrated schematically in FIG. 1 receives (see step S1 in FIG. 2) a coded digital video signal from a transmitter (not shown) via a transmission channel 1, which is for example a radio link used for simultaneously transmitting a plurality of digital video signals, an optical or electrical cable used for transmitting a plurality of such signals simultaneously, or a network used for communication between a multiplicity of subscribers. What is common to all these transmitting channels is that the bandwidth available for transmitting the coded digital video signal under consideration here to the apparatus is temporally variable, such that, irrespective of whether the rate of the video signal under consideration here is constant or variable at the transmitter end, it is not always ensured that the optimum bandwidth for transmission of the signal is available on the transmission channel 1. However, the transmission channel 1 could also be a dedicated channel for the transmission of the coded digital video signal to the apparatus, in which the variable bandwidth of the video signal can temporarily exceed the capacity of the channel.

A decoder 2 connected to the transmission channel 1 serves for decoding (step S2) the video signal received in step S1 into an intermediate picture sequence. The intermediate picture sequence is likewise a digital data stream, in which, however, data values can be identified for each pixel of a picture to be displayed, said data values specifying colour or brightness values of the pixel. To put it more precisely, the intermediate picture sequence comprises successive data blocks, each of which specifies a picture to be displayed and is subdivided into a multiplicity of sub-blocks each for example specifying a line of the picture. Coding methods for the transmission on the transmission channel 1 and decoders for the recovery of a picture sequence from the coded digital transmission signal are known per se and, as they are not specific to the invention, are not described any further here.

Furthermore, a rate counter 3 is connected to the transmission channel 1 in order to determine the data rate of the coded digital video signal (step S3). For the sake of simplicity, the rate counter 3 is illustrated such that it is connected directly to the transmission channel 1 in FIG. 1 and operates independently of the decoder 2; if a plurality of signals intended for different receivers are transmitted on the channel 1 and the decoder 2 has an input stage (not illustrated) for selecting the signal intended for the apparatus from the multiplicity of signals, the rate counter 3 can also be connected to the output of said input stage. The rate counter 3 can comprise for example an RC element and a current source which charges the capacitor of the RC element in each case upon the arrival of a data packet with a fixed quantity of charge or, in the case of packets of variable size, a quantity of charge proportional to the useful data content of the packet, while the capacitor is continuously discharged via the resistor of the RC element. With the aid of a low-pass filter, a signal representative of the average data rate can be obtained from the voltage present across the capacitor. It goes without saying that RC element and low-pass filter can also be simulated digitally, in particular by a microprocessor circuit in which a counter, in each case upon the arrival of a data packet, is incremented by a fixed value or a value corresponding to the size of the packet and is decreased at fixed time intervals, e.g. multiplied by a predetermined forgetting factor. The counter reading is then a measure of the volume of data of the coded digital video signal per unit time. If the format of the digital video signal allows for detecting the start or end of the transmission of the data corresponding to a picture, it may alternatively also be provided that decreasing of the counter, e.g. by multiplication with the forgetting factor, is effected between two respective pictures. The counter is then representative of a moving average of the volume of data of the coded digital video signal per picture.

An integrator 4, which is likewise connected to the transmission channel 1, serves for determining a measure of the motion represented in the pictures of the video signal. When using a block-based coding method in which the coded video signal contains motion vectors specifying the distance covered by a given block between two successive pictures, a measure of the motion can easily be determined by the integrator 4 extracting the motion vectors from the coded video signal (step S4), determining their absolute magnitudes and adding up said magnitudes for each picture (step S5). The motion vectors have two components, one indicating horizontal motion and one indicating vertical motion. For the sake of simplicity, the absolute magnitudes of the two components of each vector may be added together. It is also conceivable to simplify the calculation by taking account of only one of the two components of the motion vectors, preferably the horizontal component, or by taking account of only a specific fraction of the motion vectors, for example every other motion vector.

Similar as in the rate counter 3 for the data rate, a moving average may be calculated for the motion quantity in the integrator 4 (step S6). However, similar as for the data rate, the motion across a fixed number of images or for a unit time may be considered.

A control unit 5 receives the two average values from the rate counter 3 and the integrator 4 and uses them for calculating, on the basis of a predetermined function, a control parameter for a low-pass filter 6 connected to the output of the decoder 2 (step S7). The low-pass filter 6 performs a filtering in the space domain (step S8) on each picture of the intermediate picture sequence supplied by the decoder 2. A low-pass filtering parameter that can be controlled by the control unit 5 may be for example an upper limiting frequency or the amount of attenuation in the frequency range above the upper limiting frequency (stop-band). By choosing the upper limiting frequency to be all the lower, or the attenuation to be all the greater, the lower the data rate or the greater the detected motion, whenever the received volume of data does not suffice to generate a high-resolution picture without artefacts, high frequency components in the image are correspondingly attenuated to a greater extent, since artefacts typically occur on block boundaries and therefore have strong high frequency components. This measure reduces the visible block boundaries.

In general, it would also be conceivable to control the filtering at each point in time in each case on the basis of the data rate and motion quantity determined for this point in time, without prior averaging. This allows for reacting to fluctuations in the data rate or the motion quantity with a minimum delay and for performing the filtering of each individual picture depending on the motion quantity of said picture or the volume of data coding the picture in the coded digital video signal and, in this way, for representing each picture with the best resolution appropriate for it. However, abrupt changes in the filtering characteristic can again be perceptible by a viewer of the pictures, such that a compromise between high resolution and uniform filtering characteristic has to be found by suitable averaging.

The apparatus according to the invention can be fixedly combined with a display screen, which makes it possible to take account of the type of display apparatus (LCD display, plasma display or the like) in the definition of the filtering characteristic. However, it can also be combined for example with a recording device that records the filtered picture sequence for later reproduction.

1-11. (canceled)

12. A method for recovering a display picture sequence from a coded digital video signal having a variable data rate, comprising the steps of:
decoding the coded digital video signal in order to obtain an intermediate picture sequence,
filtering the intermediate picture sequence in order to obtain the display picture sequence,
detecting the data rate of the coded digital video signal,
detecting a quantity representative of the amount of motion in the images;
adaptively controlling a filtering characteristic of the filtering step on the basis of the detected data rate and the quantity representative of the amount of motion, wherein the quantity representative of the amount of motion in the images is determined from motion vectors transmitted with the coded digital video signal, and wherein the entire area of a picture is uniformly filtered using the same filter characteristic.

13. The method of claim 12, wherein the data rate is determined as the volume of data per picture of the coded digital video signal or the volume of data per unit time of the coded digital video signal.

14. The method of claim 12, wherein the coded digital video signal is a sequence of data records that each coding a picture, wherein each picture is subdivided into blocks and the data record comprises motion vectors specifying the extent of motion between a block of the coded picture and a corresponding block of a preceding or succeeding picture.

15. The method of claim 12, wherein the quantity representative motion is obtained by integration or summing up of the motion vectors of at least a part of the coded picture.

16. The method of claim 12, wherein the filtering step comprises a low-pass filtering.

17. The method of claim 12, wherein the filtering step increasingly suppresses high frequency components the lower the detected data rate and/or the higher the detected amount of motion.

18. The method of claim 12, wherein the filtering characteristic applied to a picture of the intermediate picture sequence is defined on the basis of the data rate and/or the quantity representative of motion of said picture and at least one preceding picture.

19. An apparatus for recovering a display picture sequence from a coded digital video signal having a variable data rate, comprising
a decoder for decoding the coded digital video signal in order to obtain an intermediate picture sequence,
a filter for filtering the intermediate picture sequence in order to obtain the display picture sequence,
a measuring device for detecting the data rate of the coded digital video signal,
a measuring device for detecting a quantity representative of the amount of motion in the intermediary picture sequence,
wherein a filtering characteristic of the filter can be adaptively controlled on the basis of the detected data rate and/or the detected quantity representative of the amount of motion, wherein the measuring device is adapted to determine the quantity representative of the amount of motion in the images from motion vectors transmitted with the coded digital video signal, and wherein the filter is adapted to uniformly filter the entire area of a picture using the same characteristic.
